(19) United States
(12) Patent Application Publication
(10) Pub. No.: US 2009/0199995 A1
(43) Pub. Date: Aug. 13, 2009

(54) Heat Exchange Tubing Assembly

(76) Inventors: Paul Griffee Hawkinson, McPherson, KS (US); Gary P. Morgan, McPherson, KS (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/029,326

(22) Filed: Feb. 11, 2008

(51) Int. Cl. F24D 19/02; F24H 9/06; F16L 3/00; B21D 53/06

(52) U.S. Cl. 165/49; 285/61; 29/890.045

(57) ABSTRACT

A heat exchange tubing assembly including a plurality of heat exchange tubing lengths for conveying heat exchange fluid. A plurality of cross member assemblies can extend laterally across the tubing lengths and can be secured to the tubing lengths at spaced intervals along the tubing lengths. The cross member assemblies can laterally space the tubing lengths apart from each other generally along a common plane. Each cross member assembly can include a cross member having a series of mounting structures spaced along a mounting surface of the cross member at predetermined locations. A series of tubing securement members are included and can each have a tubing trapping surface for trapping a selected tubing length against the mounting surface of the cross member. The tubing securement members can be mounted to selected mounting structures on the cross member to obtain selected lateral spacing of the tubing lengths on the cross member.

### BACKGROUND

Radiant heating and/or cooling can be provided in concrete floors by embedding circuits of flexible tubing in the concrete for circulating heating or cooling fluid. A common method of forming the circuits is to secure tubing in the desired configuration to steel reinforcement mesh or grids over which the concrete is poured. A drawback of this method is that it can be labor intensive and time consuming.

### SUMMARY

The present invention can provide a heat exchange tubing assembly including a plurality of heat exchange tubing lengths for conveying heat exchange fluid. A plurality of cross member assemblies can extend laterally across the tubing lengths and can be secured to the tubing lengths at spaced intervals along the tubing lengths. The cross member assemblies can laterally space the tubing lengths apart from each other generally along a common plane. Each cross member assembly can include a cross member having a series of mounting structures spaced along a mounting surface of the cross member at predetermined locations. A series of tubing securement members are included and can each have a tubing trapping surface for trapping a selected tubing length against the mounting surface of the cross member. The tubing securement members can be mounted to selected mounting structures on the cross member to obtain selected lateral spacing of the tubing lengths on the cross member.

In particular embodiments, the tubing lengths can be formed of flexible tubing. The heat exchange assembly can include upstream and downstream headers connected to the tubing lengths. The upstream and downstream headers can include a plurality of Tee fittings welded between pieces of pipe. The Tee fittings also being welded to the tubing lengths. Each mounting structure on a cross member can include a pair of mounting holes. Each cross member can be an elongate length of polymeric material having a channel shaped cross section for increasing stiffness. The cross member can include spaced ground mounting holes for securing the cross member to a ground or floor surface. Each tubing securement member can include an arched band extending between lateral wings. Each wing can have a self locking protrusion for locking within selected mounting holes of the mounting structures of the cross member. The lateral wings can be engageable with the mounting surface of the cross member and limit depth of insertion of the self locking protrusions into the mounting holes of the mounting structures. Each self locking protrusion can include a locating portion shaped and sized to engage selected mounting holes for locating and aligning the tubing securement member in proper position. The mounting holes of the mounting structures of the cross member and the locating portions of the self locking protrusions of the tubing securement members can be rectangular in shape.

The present invention can also provide a heat exchange tubing cross member assembly for a laterally spacing tubing lengths apart from each other along a generally common plane. The cross member assembly can include a cross member formed of an elongate length of polymeric material having a channel shaped cross section for increasing stiffness. A series of mounting structures can be spaced along a mounting surface of the cross member at predetermined locations. Each mounting structure can include a pair of mounting holes. A series of tubing securement members can each have a tubing trapping surface for trapping a selected tubing length against the mounting surface of the cross member. The tubing securement members can be mounted to selected mounting structures on the cross member to obtain selected lateral spacing of the tubing lengths on the cross member.

In particular embodiments, each tubing securement member can include an arched band extending between lateral wings. Each wing can have a self locking protrusion for locking within selected mounting holes of the mounting structures of the cross member. The lateral wings can be engageable with the mounting surface of the cross member and limit depth of insertion of the self locking protrusions into the mounting holes of the mounting structures. Each self locking protrusion can include a locating portion shaped and sized to engage selected mounting holes for locating and aligning the tubing securement member in proper position. The mounting holes of the mounting structures of the cross member and the locating portions of the self locking protrusions of the tubing securement members can be rectangular in shape. The cross member can include spaced ground mounting holes for securing the cross member to a ground or floor surface.

The present invention can also provide a tubing securement clip including an arched band having an inner tubing trapping surface for trapping tubing. The arched band can extend between lateral wings. A self locking protrusion can extend from each lateral wing away from the inner trapping surface. Each self locking protrusion can have a generally rectangular cross section with a rectangular locating portion and deflectable locking members for engaging a mating rectangular mounting hole.

The present invention can also provide a method of forming a heat exchange tubing assembly including providing a plurality of heat exchange tubing lengths for conveying heat exchange fluid. A plurality of cross member assemblies can be secured to and extend laterally across the tubing lengths at spaced intervals along the tubing lengths. The cross member assemblies can laterally space the tubing lengths apart from each other generally along a common plane. Each cross member assembly can include a cross member having a series of mounting structures spaced along a mounting surface of the cross member at predetermined locations. A series of tubing securement members can each have a tubing trapping surface for trapping a selected tubing length against the mounting surface of the cross member. The tubing securement members can be mounted to selected mounting structures on the cross member to obtain selected lateral spacing of the tubing lengths on the cross member.

In particular embodiments, flexible tubing can be provided for the tubing lengths. The tubing lengths can be connected to upstream and downstream headers. The upstream and downstream headers can be formed from a plurality of Tee fittings welded between pieces of pipe. The Tee fittings can also be welded to the tubing lengths. Each mounting structure on a cross member can be formed as a pair of mounting holes. Each cross member can be formed from an elongate length of polymeric material having a channel shaped cross section for increasing stiffness. Spaced ground mounting holes can be formed in the cross member for securing the cross member to a ground or floor surface. Each tubing securement member can be formed with an arched band extending between lateral wings. Each wing having a self locking protrusion for locking within selected mounting holes of the mounting structures of the cross member. The lateral wings can be engageable with the mounting surface of the cross member and limit depth of insertion of the self locking protrusions into the mounting holes of the mounting structures. Each self locking protrusion can be formed with a locating portion shaped and sized to engage selected mounting holes for locating and aligning the tubing securement member in proper position. The mounting holes of the mounting structures of the cross member and the locating portions of the self locking protrusions of the tubing securement members can be formed to be rectangular in shape.

The present invention can also provide a method of forming a heat exchange tubing cross member assembly for laterally spacing tubing lengths apart from each other along a generally common plane. A cross member can be provided having an elongate length of polymeric material with a channel shaped cross section for increasing stiffness. A series of mounting structures can be spaced along a mounting surface of the cross member at predetermined locations. Each mounting structure can include a pair of mounting holes. A series of tubing securement members can be provided, each having a tubing trapping surface for trapping a selected tubing length against the mounting surface of the cross member. The tubing securement members can be mounted to selected mounting structures on the cross member to obtain selected lateral spacing of the tubing lengths on the cross member.

In particular embodiments, each tubing securement member can be formed with an arched band extending between lateral wings. Each wing can have a self locking protrusion for locking within selected mounting holes of the mounting structures of the cross member. The lateral wings can be engageable with the mounting surface of the cross member and limit depth of insertion of the self locking protrusions into the mounting holes of the mounting structures. Each self locking protrusion can include a locating portion shaped and sized to engage selected mounting holes for locating and aligning the tubing securement member in proper position. The mounting holes of the mounting structures of the cross member and the locating portions of the self locking protrusions of the tubing securement members can be formed to be rectangular in shape. Spaced ground mounting holes can be formed in the cross member for securing the cross member to a ground or floor surface.

The present invention can also provide a method of forming a securement clip, including forming an arched band having an inner tubing trapping surface for trapping tubing. The arched band can extend between lateral wings. A self locking protrusion can extend from each lateral wing away from the inner trapping surface. Each self locking protrusion can have a generally rectangular cross section with a rectangular locating portion and deflectable locking members for engaging a mating rectangular mounting hole.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic side view of an embodiment of a heat exchange tubing assembly in the present invention being unrolled and covered with concrete.

FIG. 2 is a schematic plan view of an embodiment of a heat exchange tubing assembly.

FIG. 3 is a plan view of a portion of a cross member secured to tubing in a heat exchange tubing assembly.

FIG. 4 is a schematic plan view of another embodiment of a heat exchange tubing assembly.

FIG. 5 is a drawing of a portion of a header connection in the heat exchange tubing assembly of FIG. 4.

FIG. 6 is a perspective view of an embodiment of a cross member.

FIG. 7 is a plan view of the cross member of FIG. 6.

FIG. 8 is an end view of the cross member of FIG. 6.

FIG. 9 is a perspective view of an embodiment of a tubing securement clip.

FIGS. 10, 11, 12 and 13 are end, top, side and bottom views, respectively, of the tubing securement clip of FIG. 9.

FIG. 14 is another embodiment of a tubing securement clip.

FIG. 15 is another embodiment of a cross member with tubing securement clips attached thereto.

FIG. 16 is yet another embodiment of a cross member.

FIG. 17 is an enlarged portion of the cross member of FIG. 16.

FIGS. 18, 19 and 20 are side, bottom and end views, respectively, of another embodiment of a tubing securement clip.

### DETAILED DESCRIPTION

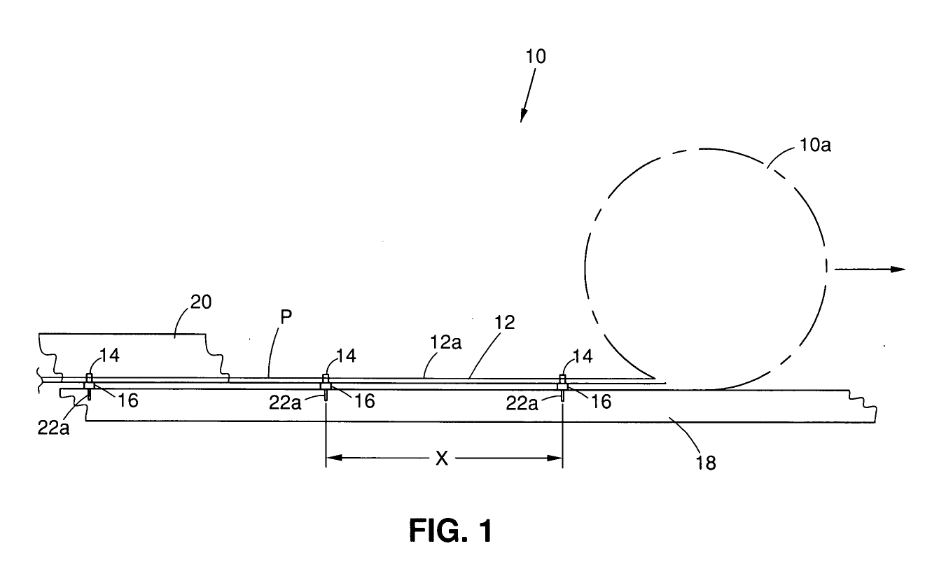

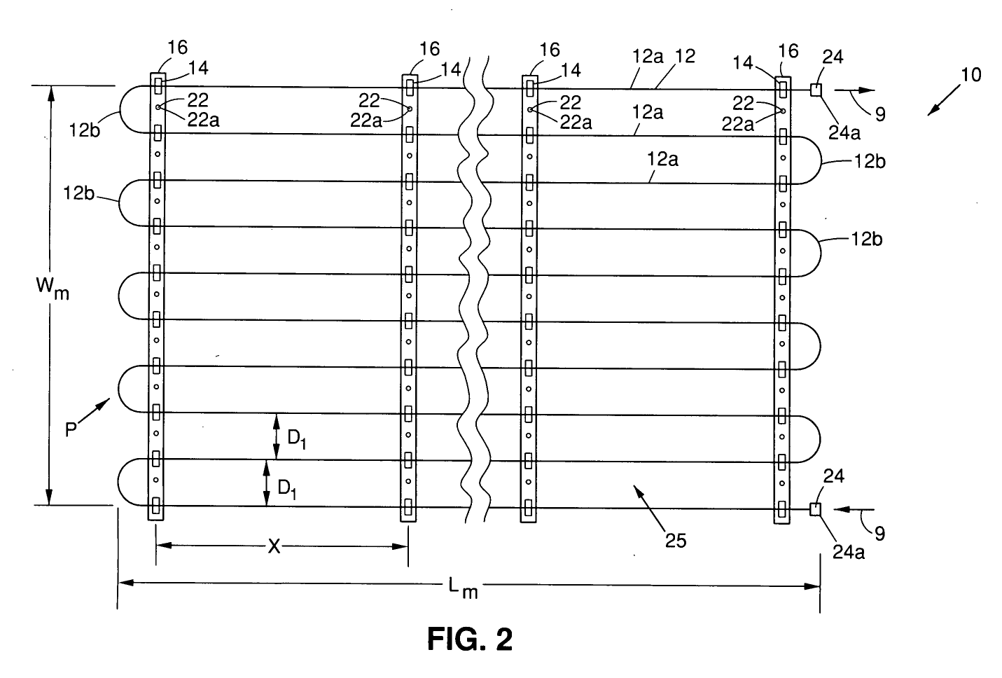

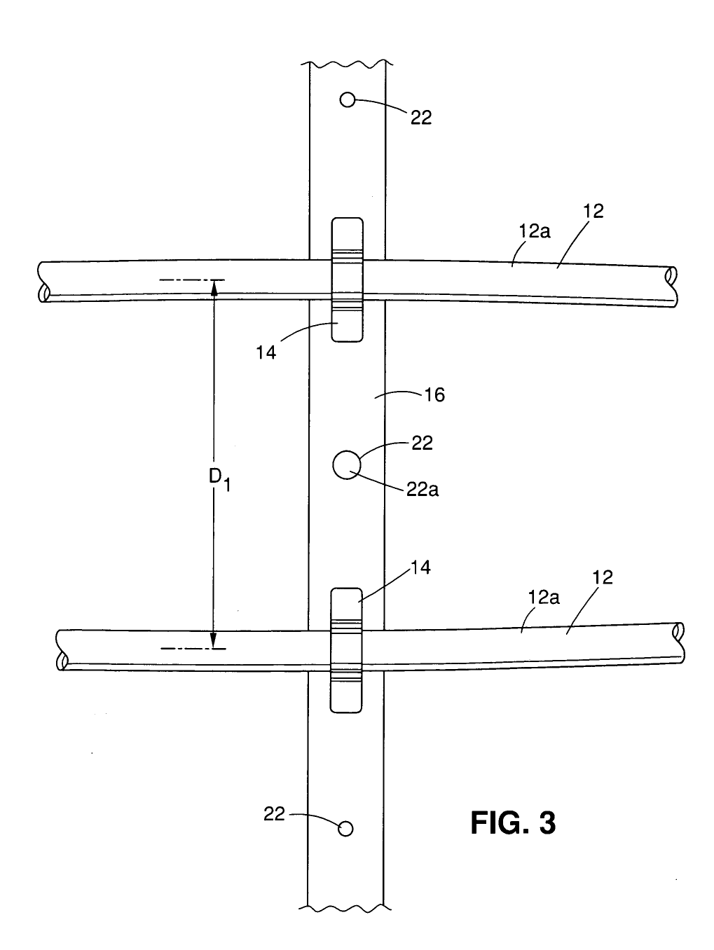

Referring to FIGS. 1-3, heat exchange tubing assembly or mat 10 having a circuit of heat exchange tubing 12, can be shipped and/or stored in a roll 10a. The mat 10 can be unrolled over a ground, sub floor or floor surface 18 which can include a surface of earth, concrete, wood, stone, insulation, composite material products, etc. A floor layer 20, such as a concrete or other suitable materials, can be spread or formed over the mat 10. Heat exchange fluid 9 for heating and/or cooling can be circulated or conveyed through the tubing 12 for providing radiant heat exchange with the floor layer 20 for heating and/or cooling.

The tubing 12 of the mat 10 can be flexible plastic tubing secured to a series of cross pieces, straps, or cross, tie or connecting members 16 by tubing securement clamps, members or clips 14 to form a mat 10 having a selected longitudinal length Lₘ and a selected lateral width Wₘ. Longitudinal tubing lengths 12a of the tubing 12 can extend along the longitudinal length Lₘ and can be laterally spaced apart from each other a selected amount by the cross members 16. The tubing lengths 12a can be spaced apart from each other generally along a common plane P in a parallel manner by equal distances or amounts D₁, for providing suitable heat transfer characteristics to the floor layer 20. In some embodiments, the tubing lengths 12a can be spaced apart various selected amounts, for example, by about 4, 6, 9, 10, 12, or 14 inches (often 4 to 14 inches, 6 to 9 inches or 6 to 12 inches) and can include a selected number of tubing lengths 12a, for example, ten tubing lengths 12a laterally positioned side by side. The number of tubing lengths 12a and the amount of spacing D₁ can determine the lateral width Wₘ. In one embodiment, the mat 10 can be about 10 feet wide (Wₘ), and in another embodiment, can be about 5 feet wide (Wₘ). The mat 10 can be of any suitable longitudinal length Lₘ. In one embodiment, the tubing 12 can be a length of tubing that is bent into a serpentine arrangement to form the tubing lengths 12a, with the tubing lengths 12a being connected to adjacent tubing lengths 12a by end or loop portions 12b of the tubing 12 extending beyond the end cross members 16. This can form an elongate convoluted flow circuit 25. The inlet and outlet to the tubing 12 can be provided at either of the tubing ends 24, which can be at the same end of the mat 10 as shown, or at opposite ends. If desired, the ends 24 can include a fitting 24a for facilitating connection to other mats 10 or other piping or tubing associated with mat 10. The tubing 12 can be formed of flexible high density polyethelyne (HDPE) and can have a ½ inch inner diameter with an ⅝ inch outer diameter. Alternatively, other suitable plastics, polymers, materials or diameters can be employed.

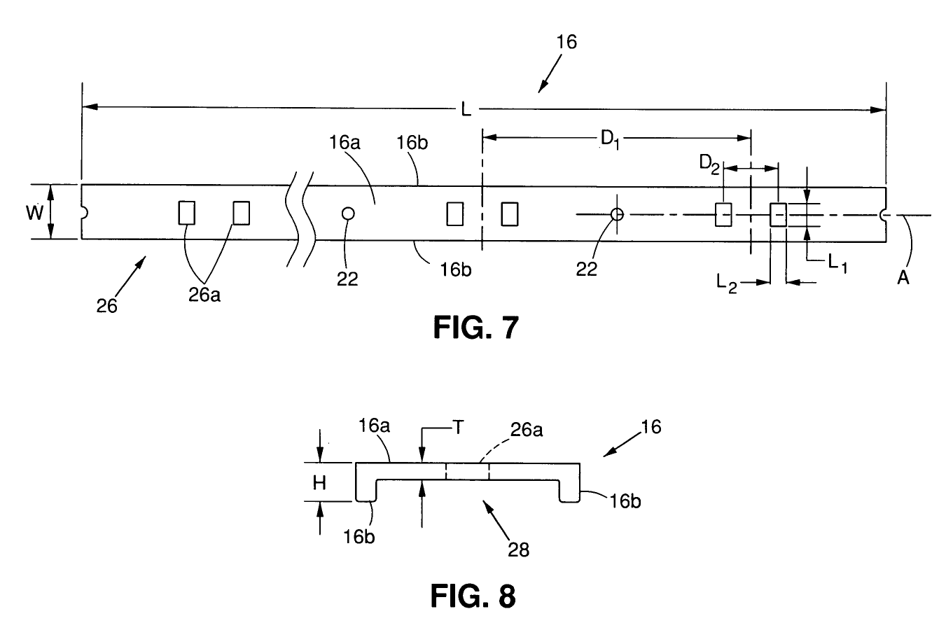

The cross members 16 can be spaced apart from each other along the longitudinal length Lₘ of the mat 10 at desired longitudinal intervals X, for example, about 2 to 5 feet apart. The cross members 16 can secure the tubing 12 together to form a generally flat mat 10 that has a definable shape and size, providing lateral stiffness laterally across the width Wₘ of mat 10 while allowing longitudinal flexibility of the tubing lengths 12a and the mat 10 along the longitudinal length Lₘ. As a result, the mat 10 can be rolled up in the longitudinal direction of the tubing lengths 12a and the longitudinal length Lₘ of mat 10. The width W (FIG. 7) of the cross members 16 can be narrow or small so that longitudinal stiffening of the tubing lengths 12a and the mat 10 along the longitudinal length Lₘ is minimized. Consequently, the cross members 16 can have a low width to length ratio W:L. The tubing 12 can be secured on top of the cross members 16, such that when the mat 10 is laid out or unrolled on the surface 18, the cross members 16 can contact the surface 18 and can be positioned between the tubing 12 and the surface 18. The mat 10 can then be secured to the surface 18 in a generally flat manner by fasteners 22a through a series of mounting holes 22 in the cross members 16. Depending upon the surface 18, the fasteners 22a can be bolts, screws, nails, stakes, barbed clips, etc. The mat 10 can be light weight, allowing for easy manual handling and installation.

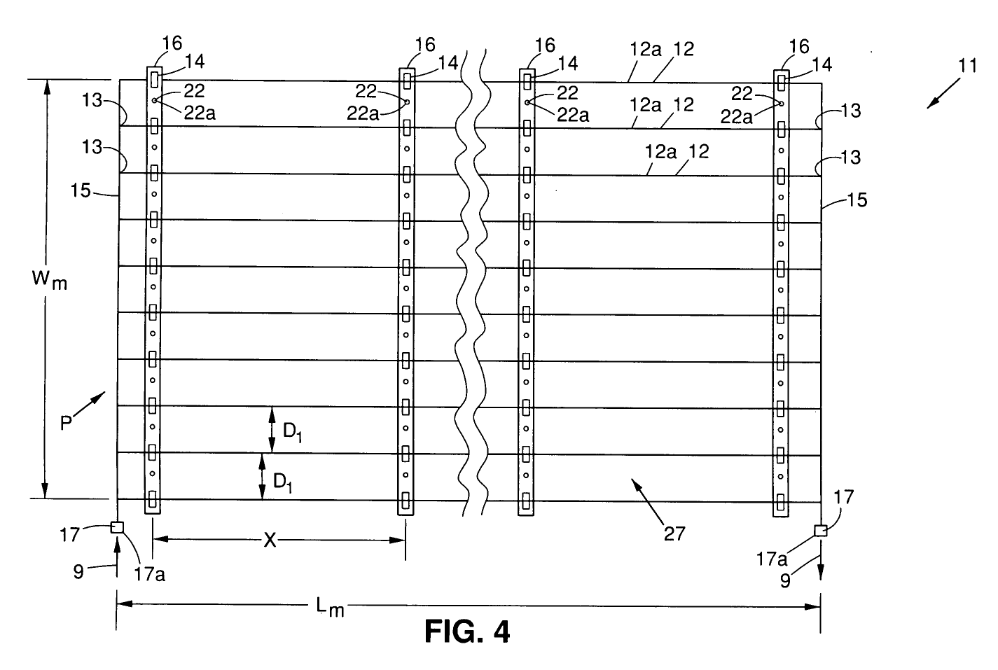

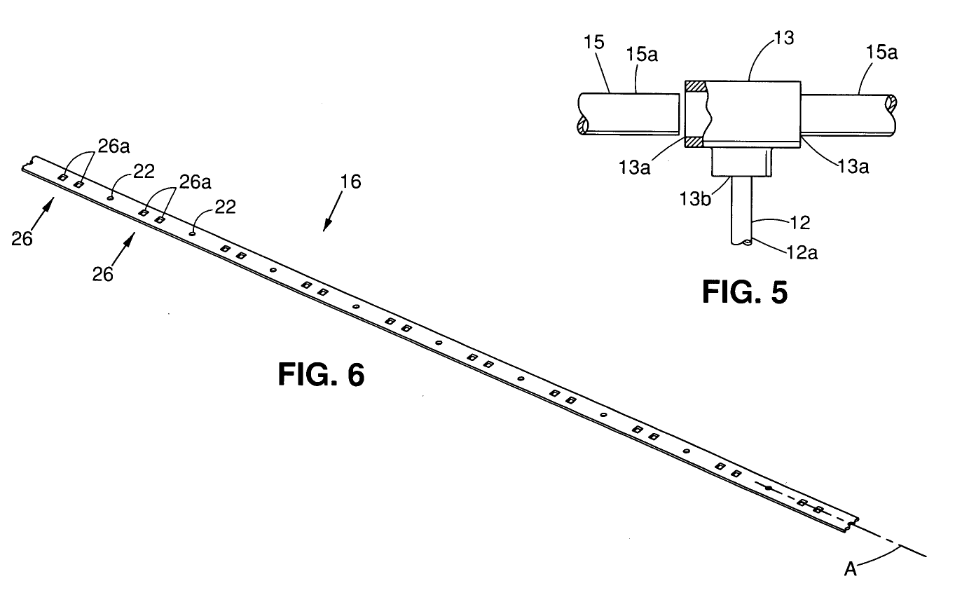

Referring to FIGS. 4 and 5, heat exchange tubing assembly or mat 11 can be substituted for mat 10 and differs from mat 10 in that mat 11 can have multiple or a plurality of tubing lengths 12a of tubing 12 secured to cross members 16 in which the ends of the tubing lengths 12a are connected to upstream and downstream, or inlet and outlet manifolds or headers 15, at joints or fittings 13. Each tubing length 12a can be connected to the headers 15 in parallel, to form a flow circuit 27 having parallel legs. The inlet/outlets 17 to the headers 15 can be at either header 15 and can be positioned at any suitable location and orientation on the headers 15. Fittings 17a can be included at the inlet/outlets 17 for facilitating connection to other mats 10 or 11, or other associated piping or tubing.

Referring to FIG. 5, each header 15 can include a series of tubing or pipe header lengths or sections 15a connected together by joints or fittings 13. The fittings 13 can be Tee fittings having opposed end openings 13a into which header sections 15a can be inserted, secured and sealed. The tubing lengths 12a can be inserted, secured and sealed within opening 13b, which can be centrally positioned at a right angle to openings 13a. The header sections 15a and fittings 13 can be formed of polyethelyne or other suitable plastics or materials. The fittings 13, header sections 15a and tubing lengths 12a can be welded or fused together, or secured by other suitable means, including threaded members. The header sections 15a can be 1 inch diameter piping or other suitable sizes. In other embodiments, the headers 15 can be formed from a single length of pipe to which the tubing lengths 12a are connected by welding, fittings, or outer suitable means or configurations.

For shipping, the mat 10 or 11 can be pressurized with air, for example, to about 20 psi and the ends 24 or headers 15 sealed. This can allow the user to measure the air pressure upon delivery with a pressure gauge to determine the existence or lack of leaks. Depending upon the situation, the pressure can be lower, or higher, for example, 40 psi. In some embodiments two mats 10 or 11 can be rolled up side by side, and can be unrolled simultaneously. The mats 10 or 11 in such a side by side configuration can be each, for example, about 5 feet wide. It is understood that the dimensions and materials of mats 10 and 11, including the piping and tubing, can vary depending upon the situation. In addition, a single mat 10 or 11 can include multiple flow circuits 25 or 27, and/or can have different numbers of tubing lengths 12a, widths Wₘ and lengths Lₘ. In some embodiments, the tubing mats 10 and 11 do not have to be generally rectangular and can have other shapes, such as triangular, curved, arched, round, polygonal, etc.

Referring to FIGS. 6-8, the cross members 16 can be formed from plastic, to be light weight, for example, polyvinylchloride (PVC), polyethylene, or other suitable plastics or polymers. Alternatively, other suitable materials can be employed, for example, wood, composites, metal, including aluminum, etc. Each cross member 16 can include a series or plurality of integral tubing securement member or clip mounting structures 26 positioned at desired predetermined intervals along the longitudinal length L of the cross member 16 for providing securement and proper or selected location for the tubing securement clips 14 and tubing lengths 12a. FIG. 6 depicts an embodiment having ten mounting structures 26 equally spaced apart from each other with nine mounting holes 22 positioned between the mounting structures 26, all extending and centrally positioned along longitudinal axis A of the cross member 16. The configuration of the mounting structures 26 can vary depending upon the configuration of the tubing securement clips 14. In the embodiment shown, mounting structures 26 can consist of a pair of spaced apart rectangular mounting holes 26a extending along longitudinal axis A. The number of mounting structures 26 and mounting holes 22 can vary, depending upon the situation at hand. Each cross member 16 and associated tubing securement clips 14 can form a cross member assembly.

Referring to FIG. 8, the cross members 16 can be channel shaped and have a flat or planar upper or top portion, or clamping, trapping or mounting surface 16a for facilitating the securement thereto of the tubing securement clips 14 and the tubing 12 along plane P. Longitudinal sides or side legs 16b can extend downwardly from the top portion 16a and form a longitudinal space or cavity 28 therebetween. The longitudinal side legs 16b provide longitudinal stiffniess which can allow the cross member 16 to be formed of plastic, as well as to have a long longitudinal length L with a short width W, and a low height H or profile.

In one embodiment, cross member 16 can be about 5 feet long, have a width W of about 1¼ inches, a height H of about ¼ inch (can be 0.215 to 0.22 inches), and a material thickness T of about 0.08 to 0.09 inches. This can provide a width to length ratio W:L of about 1:48. The mounting structures 26 can be spaced apart on center by a distance D₁ of about 6 inches, with the holes 26a being spaced apart on center a distance D₂ of about 1¼ inches. The holes 26a can have rectangular side dimensions L₁ of about ½ or 0.5 inches and L₂ of about 0.375 inches. Mounting holes 22 can be about ¼ in diameter. Cross member 16 can be extruded, have the holes 22 and 26a formed therein, and then cut to desired lengths. In other embodiments, the cross member 16 can have other suitable cross sections, such as rectangular, hexagonal or round shaped bars or tubing. In addition, depending upon the situation at hand, the dimensions of the cross member 16 can vary.

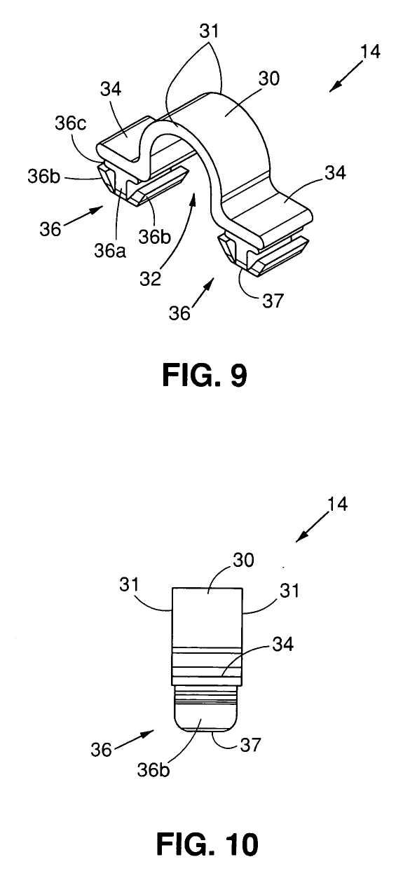

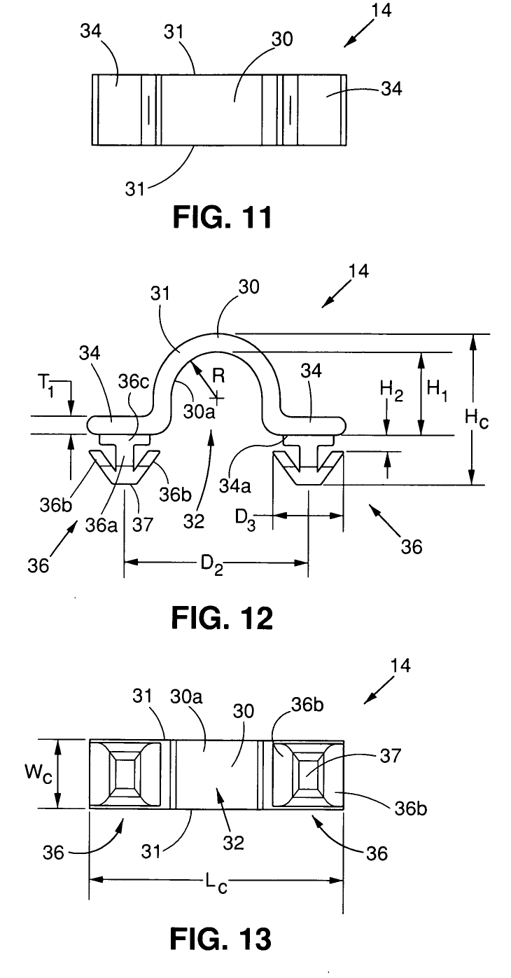

Referring to FIGS. 9-13, tubing securement clamp, member or clip 14 can be unitary and formed of a suitable plastic, such as polyethlyene, to be light weight. Alternatively, other suitable plastics, polymers, composites or other materials, such as metals, including aluminum can be employed. Tubing securement clip 14 can have a shaped tubing securement band, strip, strap, or trapping, clamping or capture portion 30 integrally positioned or extending between two laterally extending flat or planar wings 34, and can generally form an omega shape. The capture portion 30 can be arched, curved or rounded in shape. The capture portion 30 can define a cavity 32 and have an inner clamping or trapping surface 30a for clamping, trapping or capturing tubing 12 against opposed mounting surface 16a of cross member 16. The capture portion 30 can have vertical side walls and an arched upper portion or region, and can have an inner radius R at the upper region that approximates the outer radius of tubing 12. The height H₁ from the top of radius R to the bottom surface 34a of wings 34 can be about or close to the same size as the outer diameter of tubing 12. The tubing securement clip 14 and captive portion 30 can have a constant width W_{C} between end or edge faces 31. In some embodiments, the width can vary.

Each wing 34 of the tubing securement clip 14 can have a generally rectangular arrow shaped self locking protrusion 36 integrally extending from the bottom surface 34a away from the cavity 32 and the inner trapping surface 30a of capture portion 30. Each locking protrusion 36 can have a generally rectangular cross section, perimeter or outline, which generally extends between edge faces 31, and can include a locating or centering base portion 36c, and a post 36a extending therefrom having a pair of angled deflectable locking members or barbs 36d extending from opposite sides from a generally flat bottom 37. Referring to FIGS. 9, 10, 12 and 13, the locking protrusions 36 can be generally rectangular when viewed from the bottom (FIG. 13) and side (FIG. 10), and the posts 36a can be generally rectangular when viewed from the front or edge face 31 (FIGS. 9 and 12), the side (FIG. 10), towards width W_{C} and the bottom (FIG. 13). The perimeter of the locating portion 36c can be generally rectangular in shape and dimensioned for closely engaging the rectangular holes 26a in cross member 16 for locating the tubing securement clip 14. The edges of the locating portion 36c can be slightly recessed from the outer edges of the wing 34 or edge faces 31. The locking members 36b can be generally planar and deflectable towards the post 36a. The locking protrusions 36 can have angled or tapered surfaces for aiding insertion into holes 26a.

In use, when securing a tubing securement clip 14 to cross member 16 for securing, clamping or trapping tubing 12 to or against the cross member 16, the locking protrusions 36 can be inserted into a pair of holes 26a at a selected location on cross member 16. The dimension D₃ between the outer edges of the locking members 36b can be greater than the length L₂ of holes 26a in cross member 16 causing resilient deflection upon entry. Upon passing through the holes 26a, the locking members 36b can spring back to the dimension D₃, thereby trapping surface 16a of cross member 16 between the upper surfaces or edges of the locking members 36b and the bottom surface 34a of the wings 34. The wings 34 can also limit the depth of insertion of the self locking protrusions 36 into the holes 26a. The self locking protrusions 36 of tubing securement clip 14 can be spaced apart from each other the same distance D₂ as holes 26a of cross member 16. The locating portions 36c can engage the holes 26a and align the tubing securement clip 14 in the proper orientation within the holes 26a of the mounting structure 26. The rectangular locating portions 36c can closely engage the rectangular holes 26a to limit twisting of the tubing securement clip 14. The dimension D₃ between the outer edges of the locking members 36b can laterally extend beyond the locating portion 36c as seen in FIG. 12. The height H₂ between the bottom surface 34a of the wings 34 and the locking members 36b can be sized to accommodate the thickness T of cross member 16. The curved or arched capture portion 30 is of a shape that can experience little or no distortion or deformation when clamping tubing 12 against the cross member 16. The locating portions 36c of the locking protrusions 36 can limit movement of the locking protrusions 36 within holes 26a and limit spreading of the locking protrusions 36 and wings 34 away from each other to further limit deformation of the capture portion 30.

The tubing securement clip 14 can be dimensioned to capture, clamp, trap or secure tubing 12 in a secure manner to or against cross member 16 and can reduce or prevent longitudinal movement of the tubing lengths 12a relative to each other or the cross members 16. Depending upon the situation at hand, the tubing securement clip 14 can be sized to slightly compress the tubing 12 or to loosely capture the tubing 12. In one embodiment, radius R can be about 0.313 inches, height H₁, can be about 0.591 to 0.593 inches, height H₂ can be about ⅛ or 0.125 inches, thickness T₁ of the clip 14 can be about ⅛ (0.125 to 0.13) inches, the distance D₂ between the centers of the locking protrusions 36 can be about 1¼ inches, dimension D₃ of the locking protrusions 36 can be about 0.490 inches, the length of the locking protrusions 36 extending from wings 34 can be about 0.345 inches long, the locking members 36b can be at about a 60° angle to each other, the length L_{c} of the clip 14 from the ends of wings 34 can be about 1¾ (1.725) inches, the width W_{C} of clip 14 can be about ½ (0.45) inches, and the height H_{c} of clip 14 can be about 1 1/16 (1.07) inches. It is understood that the dimensions can vary depending upon the situation at hand. In addition, the capture portion 30 and cavity 32 can be angled or rectangular instead of arched, and wings 34 do not have to be flat or planar.

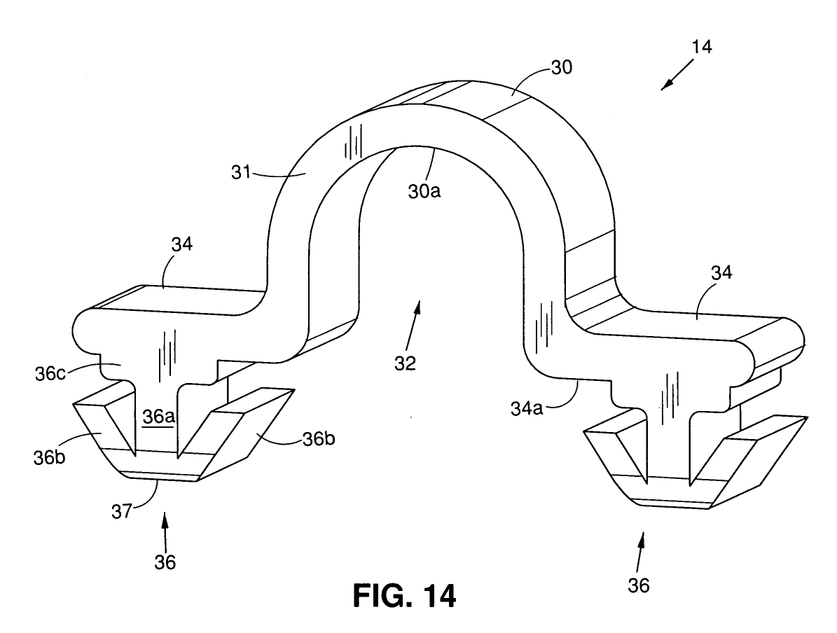

Referring to FIG. 14, tubing securement member or clip 14 can have locking protrusions 36 in which the locating portions 36c are not recessed from the wings 34 on front and rear surfaces or edge faces 31, and in such a configuration, clip 14 can be formed by extruding an elongate profile and cutting the profile to form individual tubing securement clips 14.

Although the locking protrusions 36 have a generally rectangular plan view outline with a rectangular locating portion 36c, in some embodiments, the locking protrusions 36 can be generally round in shape with a round locating portion 36c. In such a case, the holes in the mounting structures 26 of the cross members 16 would be appropriately shaped.

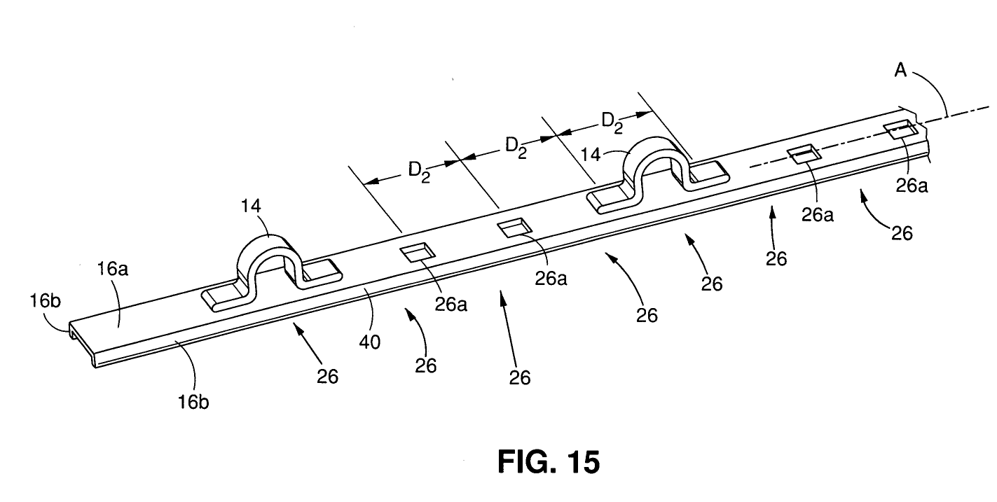

Referring to FIG. 15, cross piece, strap or cross, tie or connecting member 40 is another embodiment of a cross member having mounting holes 26a extending along the longitudinal axis A. Each hole 26a can be spaced apart from each other by a distance D₂ to form mounting structures 26 between any two mounting holes 26a. As a result, cross member 40 can allow different or flexible spacing between the tubing securement clips 14 and tubing lengths 12a, depending upon which holes 26a and spacing is selected. The cross member 40 can be secured to surface 18 with a fastener 22a through the unused holes 26a. The fasteners 22a can have enlarged heads, or alternatively, washers can be employed.

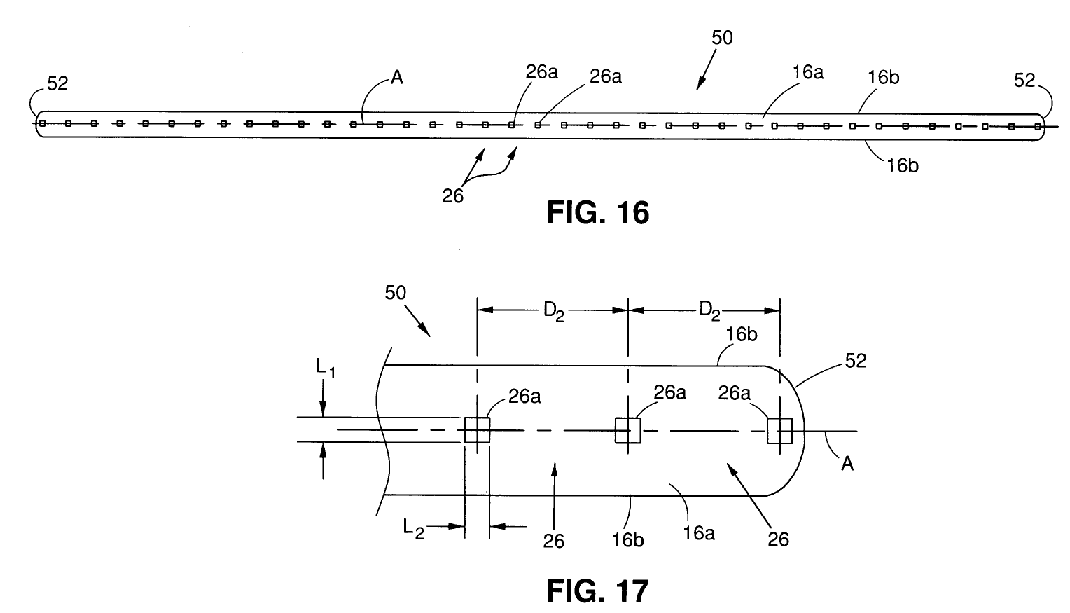

Referring to FIGS. 16 and 17, cross piece, strap, or cross, tie or connecting member 50 is another embodiment of a cross member that differs from cross member 40 in that the ends 52 of the cross member 50 can be rounded. In addition, the mounting holes 26a can be square where L₁=L₂. In one embodiment, L₁ and L₂ can be about ¼ inch and spaced apart on center a distance D₂ of about 1½ inches.

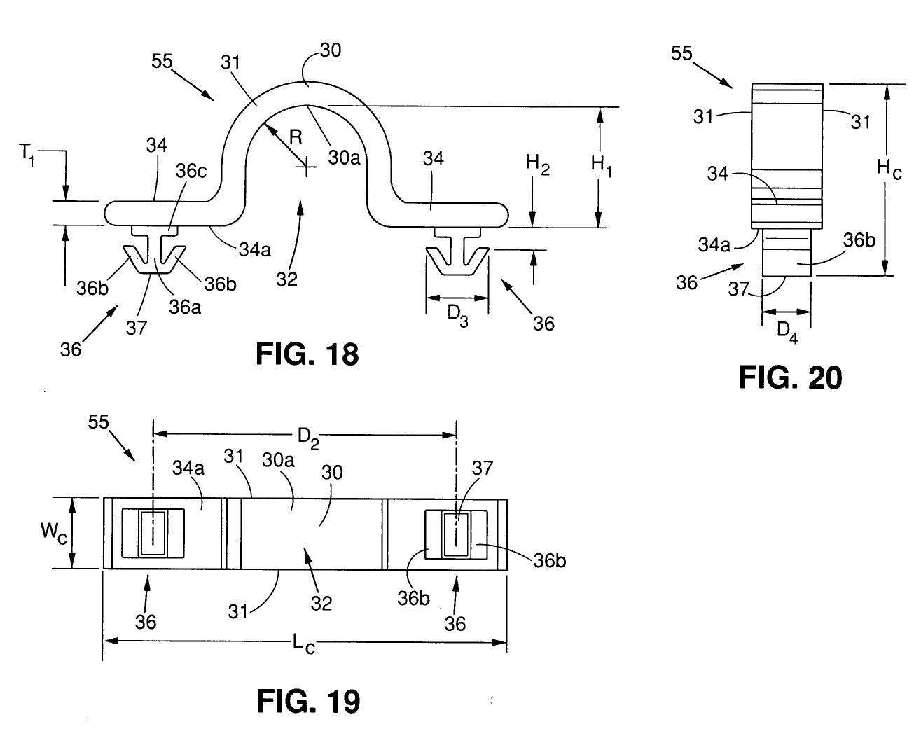

Referring to FIGS. 18-20, tubing securement clamp, member or clip 55 is another embodiment of a tubing securement clip that differs from tubing securement clip 14 in that the locking protrusions 36 can be spaced away from the edge faces 31 and ends of the wings 34. As a result, the bottom surface 34a of the wings 34 can surround the locking protrusions 36. The tubing securement clip 55 and the locking protrusions 36 can be configured and dimensioned for use with cross member 50. The locking protrusions 36 can be dimensional, spaced and configured for engaging the square holes 26a of cross member 50. The rectangular locating portions 36c can be square for engaging square holes 26a.

For example, the length of the protrusions 36 can be about ¼ inch (can be 0.224 inches), dimension D₃ can be about 0.3 inches, and dimension D₄ can be about ¼ (0.24) inches. The length L_{c} can be about 2 inches, the width W_{C} can be about 0.35 inches, and the distance D₂ can be about 1½ inches.

While this invention has been particularly shown and described with references to example embodiments thereof, it will be understood by those skilled in the art that various changes in form and details may be made therein without departing from the scope of the invention encompassed by the appended claims.

For example, dimensions, materials and shapes can be varied, depending upon the situation at hand. In addition, features of mats 10 and 11 can be combined or omitted. In some embodiments, the cross members 16, 40 and 50, and tubing securement clips 14 and 55 can be of other suitable configurations.

What is claimed is:

1. A heat exchange tubing assembly comprising:
a plurality of heat exchange tubing lengths for conveying heat exchange fluid; and
a plurality of cross member assemblies extending laterally across the tubing lengths and secured to the tubing lengths at spaced intervals along the tubing lengths, the cross member assemblies laterally spacing the tubing lengths apart from each other generally along a common plane, each cross member assembly comprising a cross member having a series of mounting structures spaced along a mounting surface of the cross member at predetermined locations, and a series of tubing securement members each having a tubing trapping surface for trapping a selected tubing length against the mounting surface of the cross member, the tubing securement members being mounted to selected mounting structures on the cross member to obtain selected lateral spacing of the tubing lengths on the cross member.

2. The heat exchange tubing assembly of claim 1 in which the tubing lengths are formed of flexible tubing.

3. The heat exchange assembly of claim 2 further comprises upstream and downstream headers connected to the tubing lengths.

4. The heat exchange assembly of claim 3 in which the upstream and downstream headers comprise a plurality of Tee fittings welded between pieces of pipe, the Tee fittings also being welded to the tubing lengths.

5. The heat exchange assembly of claim 1 in which each mounting structure on said cross member comprise a pair of mounting holes.

6. The heat exchange assembly of claim 5 in which said cross member comprises an elongate length of polymeric material having a channel shaped cross section for increasing stiffness.

7. The heat exchange assembly of claim 6 in which said cross member includes spaced ground mounting holes for securing said cross member to a ground surface.

8. The heat exchange assembly of claim 5 in which each tubing securement member comprises an arched band extending between lateral wings, each wing having a self locking protrusion for locking within selected mounting holes of the mounting structures of said cross member, the lateral wings engageable with the mounting surface of said cross member and limiting depth of insertion of the self locking protrusions into the mounting holes of the mounting structures.

9. The heat exchange assembly of claim 8 in which each self locking protrusion includes a locating portion shaped and sized to engage selected mounting holes for locating and aligning the tubing securement member in proper position.

10. The heat exchange assembly of claim 9 in which the mounting holes of the mounting structures of said cross member and the locating portions of the self locking protrusions of the tubing securement members are rectangular in shape.

11. A heat exchange tubing cross member assembly for laterally spacing tubing lengths apart from each other along a generally common plane, the cross member assembly comprising:
a cross member comprising an elongate length of polymeric material having a channel shaped cross section for increasing stiffness and having a series of mounting structures spaced along a mounting surface of the cross member at predetermined locations, each mounting structure comprising a pair of mounting holes; and
a series of tubing securement members each having a tubing trapping surface for trapping a selected tubing length against the mounting surface of the cross member, the tubing securement members being mounted to selected mounting structures on the cross member to obtain selected lateral spacing of the tubing lengths on the cross member.

12. The cross member assembly of claim 11 in which each tubing securement member comprises an arched band extending between lateral wings, each wing having a self locking protrusion for locking within selected mounting holes of the mounting structures of the cross member, the lateral wings engageable with the mounting surface of the cross member and limiting depth of insertion of the self locking protrusions into the mounting holes of the mounting structures, each self locking protrusion including a locating portion shaped and sized to engage selected mounting holes for locating and aligning the tubing securement member in proper position.

13. The cross member assembly of claim 12 in which the mounting holes of the mounting structures of the cross member and the locating portions of the self locking protrusions of the tubing securement members are rectangular in shape.

14. The cross member assembly of claim 13 in which the cross member includes spaced ground mounting holes for securing the cross member to a ground surface.

15. A tubing securement clip comprising:
an arched band having an inner tubing trapping surface for trapping tubing, the arched band extending between lateral wings; and
a self locking protrusion extending from each lateral wing away from the inner trapping surface, each self locking protrusion having a generally rectangular cross section with a rectangular locating portion and deflectable locking members for engaging a mating rectangular mounting hole.

16. A method of forming a heat exchange tubing assembly comprising:
providing a plurality of heat exchange tubing lengths for conveying heat exchange fluid; and
securing a plurality of cross member assemblies to and extending laterally across the tubing lengths at spaced intervals along the tubing lengths, the cross member assemblies laterally spacing the tubing lengths apart from each other generally along a common plane, each cross member assembly comprising a cross member having a series of mounting structures spaced along a mounting surface of the cross member at predetermined locations, and a series of tubing securement members each having a tubing trapping surface for trapping a selected tubing length against the mounting surface of the cross member, the tubing securement members being mounted to selected mounting structures on the cross member to obtain selected lateral spacing of the tubing lengths on the cross member.

17. The method of claim 16 further comprising providing flexible tubing for the tubing lengths.

18. The method of claim 17 further comprising connecting the tubing lengths to upstream and downstream headers.

19. The method of claim 18 further comprising forming the upstream and downstream headers from a plurality of Tee fittings welded between pieces of pipe, the Tee fittings also being welded to the tubing lengths.

20. The method of claim 16 further comprising forming each mounting structure on said cross member as a pair of mounting holes.

21. The method of claim 20 further comprising forming said cross member from an elongate length of polymeric material having a channel shaped cross section for increasing stiffniess.

22. The method of claim 21 further comprising forming spaced ground mounting holes in said cross member for securing said cross member to a ground surface.

23. The method of claim 20 further comprising forming each tubing securement member with an arched band extending between lateral wings, each wing having a self locking protrusion for locking within selected mounting holes of the mounting structures of said cross member, the lateral wings engageable with the mounting surface of said cross member and limiting depth of insertion of the self locking protrusions into the mounting holes of the mounting structures.

24. The method of claim 23 further comprising forming each self locking protrusion with a locating portion shaped and sized to engage selected mounting holes for locating and aligning the tubing securement member in proper position.

25. The method of claim 24 further comprising forming the mounting holes of the mounting structures of said cross member and the locating portions of the self locking protrusions of the tubing securement members to be rectangular in shape.

26. A method of forming a heat exchange tubing cross member assembly for laterally spacing tubing lengths apart from each other along a generally common plane comprising:
providing a cross member comprising an elongate length of polymeric material having a channel shaped cross section for increasing stiffniess and having a series of mounting structures spaced along a mounting surface of the cross member at predetermined locations, each mounting structure comprising a pair of mounting holes; and
providing a series of tubing securement members each having a tubing trapping surface for trapping a selected tubing length against the mounting surface of the cross member, the tubing securement members being mounted to selected mounting structures on the cross member to obtain selected lateral spacing of the tubing lengths on the cross member.

27. The method of claim 26 further comprising forming each tubing securement member with an arched band extending between lateral wings, each wing having a self locking protrusion for locking within selected mounting holes of the mounting structures of the cross member, the lateral wings engageable with the mounting surface of the cross member and limiting depth of insertion of the self locking protrusions into the mounting holes of the mounting structures, each self locking protrusion including a locating portion shaped and sized to engage selected mounting holes for locating and aligning the tubing securement member in proper position.

28. The method of claim 27 further comprising forming the mounting holes of the mounting structures of the cross member and the locating portions of the self locking protrusions of the tubing securement members to be rectangular in shape.

29. The method of claim 28 further comprising forming spaced ground mounting holes in the cross member for securing the cross member to a ground surface.

30. A method of forming a tubing securement clip comprising:
forming an arched band having an inner tubing trapping surface for trapping tubing, the arched band extending between lateral wings; and
extending a self locking protrusion from each lateral wing away from the inner trapping surface, each self locking protrusion having a generally rectangular cross section with a rectangular locating portion and deflectable locking members for engaging a mating rectangular mounting hole.
